(19) United States
(12) Patent Application Publication
(10) Pub. No.: US 2006/0218800 A1
(43) Pub. Date: Oct. 5, 2006

(54) Paring knife

(76) Inventor: Michael Stevens, Cleveland, OH (US)

Correspondence Address: ROGER A. GILCREST, 250 WEST STREET, COLUMBUS, OH, 43216-7513, US

(21) Appl. No.: 11/098,263

(22) Filed: Apr. 4, 2005

(51) Int. Cl. B26B 3/00

(52) U.S. Cl. 30/314

(57) ABSTRACT

A method of using a knife. The method includes providing a knife having a blade portion and a handle portion. The handle portion has a pivot point at one end of the handle portion and a knob defined by two cupped regions at the other end of the handle portion. The method includes placing a thumb in the pivot point and moving the blade portion of the knife.

### BACKGROUND OF THE INVENTION

Knives are useful. Unfortunately, conventional commercially available cutlery knives are often hard to handle and use. They can lead to hand and arm stress sometimes resulting in carpel tunnel syndrome, particularly with prolonged use. This can be due, in part, to the amount of pressure required for cutting and the non-ergonomic shape of the handle. For example, those who cook at home, professional chefs, butchers, senior citizens, handicapped people with disabilities and the like can become fatigued with prolonged use of conventional knives. There is a long-felt need for an improved knife that requires less pressure to cut with and ergonomically hold securely.

### SUMMARY OF THE INVENTION

The above advantages as well as other advantages not specifically enumerated are achieved by a method of using a knife. The method includes providing a knife having a blade portion and a handle portion. The handle portion has a pivot point at one end of the handle portion and a knob defined by two cupped regions at the other end of the handle portion. The method includes placing a thumb in the pivot point and moving the blade portion of the knife.

Various advantages of this invention will become apparent to those skilled in the art from the following detailed description of the preferred embodiment, when read in light of the accompanying drawings.

### BRIEF DESCRIPTION OF THE DRAWINGS

FIG. 1 is an elevational side view of a relatively medium sized machete knife in accordance with the present invention.

FIG. 2 is an elevational side view of a relatively large sized machete knife in accordance with the present invention.

FIG. 3 is an elevational side view of a relatively medium sized steak knife in accordance with the present invention.

FIG. 4 is an elevational side view of a relatively large sized clever knife in accordance with the present invention.

FIG. 5 is an elevational side view of a relatively large sized knife having a forked end in accordance with the present invention.

FIG. 6 is an elevational side view of a relatively large sized fillet knife in accordance with the present invention.

FIG. 7 is an elevational side view of a relatively large sized knife having a forked end in accordance with the present invention.

FIG. 8 is an elevational side view of a relatively large sized sports military style knife with a jagged edge in accordance with the present invention.

FIG. 9 is an elevational side view of a relatively large sized handle covering for use with one or more of the cutting implements shown in this application in accordance with the present invention.

FIG. 10 is an elevational side view of a relatively large sized bread knife in accordance with the present invention.

FIG. 11 is an elevational side view of a relatively large sized butcher knife in accordance with the present invention.

FIG. 12 is an elevational side view of a relatively large sized carver knife in accordance with the present invention.

FIG. 13 is an elevational side view of a relatively medium sized paring knife in accordance with the present invention.

FIG. 14 is an elevational side view of a relatively medium sized bird's beak knife in accordance with the present invention.

FIG. 15 is an elevational side view of a relatively medium sized dicing knife in accordance with the present invention.

FIG. 16 is an elevational side view of a relatively medium sized bagel knife in accordance with the present invention.

FIG. 17 is an elevational side view of a relatively medium sized fillet knife in accordance with the present invention.

FIG. 18 is an elevational side view of a relatively medium sized knife having a forked end in accordance with the present invention.

FIG. 19 is an elevational side view of a relatively medium sized handle covering for use with one or more of the cutting implements shown in this application in accordance with the present invention.

FIG. 20 is an elevational side view of a relatively mini or small sized handle covering for use with one or more of the cutting implements shown in this application in accordance with the present invention.

FIG. 21 is an elevational side view of a relatively small sized bird's beak knife in accordance with the present invention.

FIG. 22 is an elevational side view of a relatively small sized bread knife in accordance with the present invention.

FIG. 23 is an elevational side view of a relatively small sized carver knife in accordance with the present invention.

FIG. 24 is an elevational side view of a relatively small sized paring knife in accordance with the present invention.

FIG. 25 is an elevational side view of a relatively medium sized paring knife in accordance with the present invention.

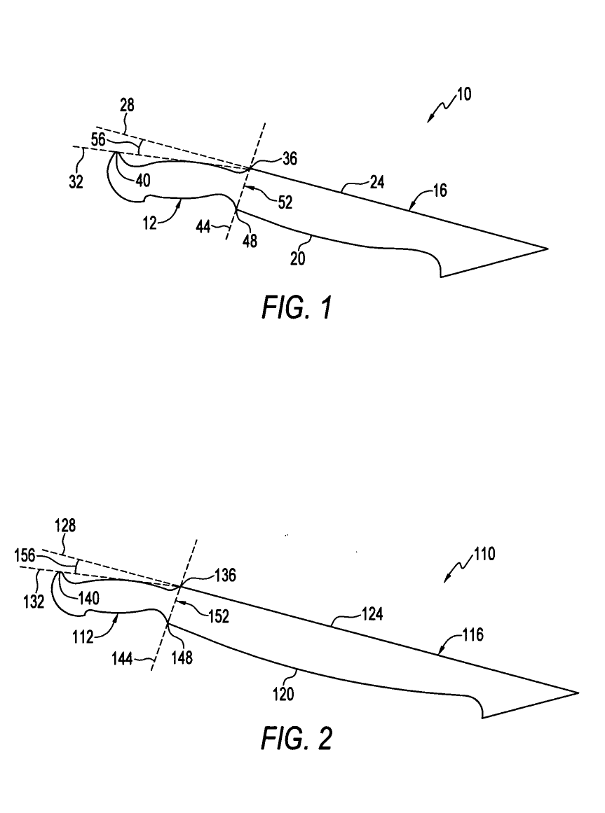

### DETAILED DESCRIPTION OF THE INVENTION

Preliminarily, it should be noted that certain directional terms that may be used herein are used to facilitate the description of the invention. Unless otherwise specified or made apparent by the context of the discussion, such terms and the like should be interpreted with reference to the figure(s) under discussion. Such terms are not intended as a limitation on the position in which the invention or components may be used. Indeed, it is contemplated that the components of the invention may be easily positioned in any desired orientation for use. Likewise, numerical terms such as for example “first” and “second” are not intended as a limitation or to imply a sequence, unless otherwise specified or made apparent by the context of the discussion.

Referring now to the drawings, there is illustrated a machete, indicated generally at 10, in accordance with the present invention. The term “machete” is understood to include a relatively large and/or heavy knife used for cutting plant matter and/or a weapon. The term “knife” is understood to include a cutting instrument consisting of a sharp blade secured to or having a handle. As such the term knife includes a cleaver, a machete, and a wide number of other styles of blades and/or handles. For purposes of clarity, the knives are shown apart from their respective handle coverings. The handle coverings may be made of wood, plastic, or any other suitable material. The term “terminal point” use herein is understood to include those points that are of or relating to an end, extremity, and/or boundary.

The illustrated machete 10 includes a handle portion 12 and a blade portion 16. The handle portion 12 and the blade portion 16 are operatively connected. The handle portion 12 and the blade portion 16 are generally planar. The term “operatively connected” is understood to include a linking together of the portions under consideration and may include a physical engagement and/or a functional or operational connection. The illustrated blade portion 16 includes a generally sharpened cutting edge 20. The cutting edge 20 may be serrated and/or plain edged. The illustrated cutting edge 20 is plain edged. The illustrated blade portion 16 also includes a back edge 24. The illustrated back edge 24 is generally straight. The back edge 24 of the blade portion 16 is generally aligned along a first axis 28, as shown.

The handle portion 12 is generally aligned along a second axis 32, as shown. The illustrated second axis 32 generally extends from a first terminal point 36 on the back edge 24 of the blade portion 16 to an upward tip 40 of the handle portion 12. An illustrated third axis 44 intersects the first terminal point 36 on the back edge 24 of the blade portion 16 and the second terminal point 48 on the cutting edge 20 of the blade portion 16. It will be appreciated that the third axis 44 is generally perpendicular to the first axis 28, as shown.

The illustrated machete 10 includes a joint 52 as shown. The term “joint” is understood to include a place and/or location where two things and/or parts are joined. It will be appreciated that the illustrated joint 52 is the place where the handle portion 12 and the blade portion 16 are joined. The illustrated joint 52 is generally about where the third axis 44 intersects the first terminal point on the back edge 24 of the blade portion 16 and the second terminal point on the cutting edge 20 of the blade portion 16.

It will be noted that the first axis 28 and the second axis 32 define an angle 56. The angle 56 is preferably within the range of from about one degree to about twenty degrees. The illustrated angle 56 is more preferably about fifteen degrees. With respect to the angle 56, and the general positioning of the handle portion 12 and the blade portion 16, it will be appreciated that the other knives are shaped in an analogous fashion. For purposes of consistency, ease of reading, and completeness of disclosure, the numbering scheme shown for the machete 10 will be employed with a change of numbering in the hundreds position unless otherwise noted.

Referring now to FIG. 2, the illustrated relatively large sized machete 110 includes a handle portion 112 and a blade portion 116. The handle portion 112 and the blade portion 116 are operatively connected. The handle portion 112 and the blade portion 116 are generally planar. The illustrated blade portion 116 includes a generally sharpened cutting edge 120. The cutting edge 120 may be serrated and/or plain edged. The illustrated blade portion 116 also includes a back edge 124. The illustrated back edge 124 is generally straight. The back edge 124 of the blade portion 116 is generally aligned along a first axis 128, as shown.

The handle portion 112 is generally aligned along a second axis 132, as shown. The illustrated second axis 132 generally extends from a first terminal point 136 on the back edge 124 of the blade portion 116 to an upward tip 140 of the handle portion 112. An illustrated third axis 144 intersects the first terminal point 136 on the back edge 124 of the blade portion 116 and the second terminal point 148 on the cutting edge 120 of the blade portion 116. It will be appreciated that the third axis 144 is generally perpendicular to the first axis 128, as shown.

The illustrated machete 110 includes a joint 152 as shown. It will be appreciated that the illustrated joint 152 is the place where the handle portion 112 and the blade portion 116 are joined. The illustrated joint 152 is generally about where the third axis 144 intersects the first terminal point on the back edge 124 of the blade portion 116 and the second terminal point on the cutting edge 120 of the blade portion 116.

It will be noted that the first axis 128 and the second axis 132 define an angle 156. The angle 156 is preferably within the range of from about one degree to about twenty degrees. The illustrated angle 156 is more preferably about fifteen degrees.

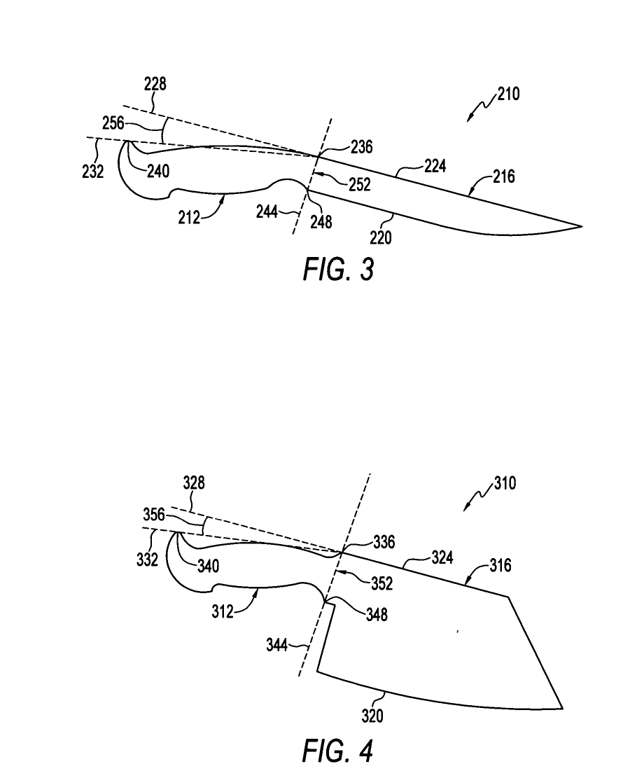

Referring now to FIG. 3, the illustrated relatively medium sized steak knife 210 includes a handle portion 212 and a blade portion 216. The handle portion 212 and the blade portion 216 are operatively connected. The handle portion 212 and the blade portion 216 are generally planar. The illustrated blade portion 216 includes a generally sharpened cutting edge 220. The cutting edge 220 may be serrated and/or plain edged. The illustrated blade portion 216 also includes a back edge 224. The illustrated back edge 224 is generally straight. The back edge 224 of the blade portion 216 is generally aligned along a first axis 228, as shown.

The handle portion 212 is generally aligned along a second axis 232, as shown. The illustrated second axis 232 generally extends from a first terminal point 236 on the back edge 224 of the blade portion 216 to an upward tip 240 of the handle portion 212. An illustrated third axis 244 intersects the first terminal point 236 on the back edge 224 of the blade portion 216 and the second terminal point 248 on the cutting edge 220 of the blade portion 216. It will be appreciated that the third axis 244 is generally perpendicular to the first axis 228, as shown.

The illustrated knife 210 includes a joint 252 as shown. It will be appreciated that the illustrated joint 252 is the place where the handle portion 212 and the blade portion 216 are joined. The illustrated joint 252 is generally about where the third axis 244 intersects the first terminal point on the back edge 224 of the blade portion 216 and the second terminal point on the cutting edge 220 of the blade portion 216.

It will be noted that the first axis 228 and the second axis 232 define an angle 256. The angle 256 is preferably within the range of from about one degree to about twenty degrees. The illustrated angle 256 is more preferably about fifteen degrees.

Referring now to FIG. 4, the illustrated relatively large sized clever knife 310 includes a handle portion 312 and a blade portion 316. The handle portion 312 and the blade portion 316 are operatively connected. The handle portion 312 and the blade portion 316 are generally planar. The illustrated blade portion 316 includes a generally sharpened cutting edge 320. The cutting edge 320 may be serrated and/or plain edged. The illustrated blade portion 316 also includes a back edge 324. The illustrated back edge 324 is generally straight. The back edge 324 of the blade portion 316 is generally aligned along a first axis 328, as shown.

The handle portion 312 is generally aligned along a second axis 332, as shown. The illustrated second axis 332 generally extends from a first terminal point 336 on the back edge 324 of the blade portion 316 to an upward tip 340 of the handle portion 312. An illustrated third axis 344 intersects the first terminal point 336 on the back edge 324 of the blade portion 316 and the second terminal point 348 on the cutting edge 320 of the blade portion 316. It will be appreciated that the third axis 344 is generally perpendicular to the first axis 328, as shown.

The illustrated knife 310 includes a joint 352 as shown. It will be appreciated that the illustrated joint 352 is the place where the handle portion 312 and the blade portion 316 are joined. The illustrated joint 352 is generally about where the third axis 344 intersects the first terminal point on the back edge 324 of the blade portion 316 and the second terminal point on the cutting edge 320 of the blade portion 316.

It will be noted that the first axis 328 and the second axis 332 define an angle 356. The angle 356 is preferably within the range of from about one degree to about twenty degrees. The illustrated angle 356 is more preferably about fifteen degrees.

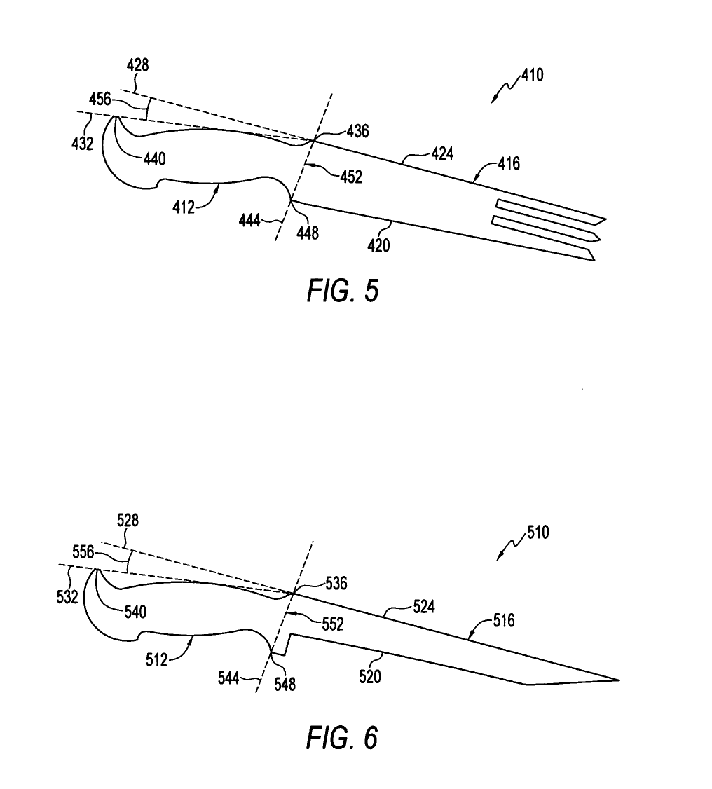

Referring now to FIG. 5, the illustrated relatively large sized knife having a forked end 410 includes a handle portion 412 and a blade portion 416. The handle portion 412 and the blade portion 416 are operatively connected. The handle portion 412 and the blade portion 416 are generally planar. The illustrated blade portion 416 includes a generally sharpened cutting edge 420. The cutting edge 420 may be serrated and/or plain edged. The illustrated blade portion 416 also includes a back edge 424. The illustrated back edge 424 is generally straight. The back edge 424 of the blade portion 416 is generally aligned along a first axis 428, as shown.

The handle portion 412 is generally aligned along a second axis 432, as shown. The illustrated second axis 432 generally extends from a first terminal point 436 on the back edge 424 of the blade portion 416 to an upward tip 440 of the handle portion 412. An illustrated third axis 444 intersects the first terminal point 436 on the back edge 424 of the blade portion 416 and the second terminal point 448 on the cutting edge 420 of the blade portion 416. It will be appreciated that the third axis 444 is generally perpendicular to the first axis 428, as shown.

The illustrated knife 410 includes a joint 452 as shown. It will be appreciated that the illustrated joint 452 is the place where the handle portion 412 and the blade portion 416 are joined. The illustrated joint 452 is generally about where the third axis 444 intersects the first terminal point on the back edge 424 of the blade portion 416 and the second terminal point on the cutting edge 420 of the blade portion 416.

It will be noted that the first axis 428 and the second axis 432 define an angle 456. The angle 456 is preferably within the range of from about one degree to about twenty degrees. The illustrated angle 456 is more preferably about fifteen degrees.

Referring now to FIG. 6, the illustrated relatively large sized fillet knife 510 includes a handle portion 512 and a blade portion 516. The handle portion 512 and the blade portion 516 are operatively connected. The handle portion 512 and the blade portion 516 are generally planar. The illustrated blade portion 516 includes a generally sharpened cutting edge 520. The cutting edge 520 may be serrated and/or plain edged. The illustrated blade portion 516 also includes a back edge 524. The illustrated back edge 524 is generally straight. The back edge 524 of the blade portion 516 is generally aligned along a first axis 528, as shown.

The handle portion 512 is generally aligned along a second axis 532, as shown. The illustrated second axis 532 generally extends from a first terminal point 536 on the back edge 524 of the blade portion 516 to an upward tip 540 of the handle portion 512. An illustrated third axis 544 intersects the first terminal point 536 on the back edge 524 of the blade portion 516 and the second terminal point 548 on the cutting edge 520 of the blade portion 516. It will be appreciated that the third axis 544 is generally perpendicular to the first axis 528, as shown.

The illustrated knife 510 includes a joint 552 as shown. It will be appreciated that the illustrated joint 552 is the place where the handle portion 512 and the blade portion 516 are joined. The illustrated joint 552 is generally about where the third axis 544 intersects the first terminal point on the back edge 524 of the blade portion 516 and the second terminal point on the cutting edge 520 of the blade portion 516.

It will be noted that the first axis 528 and the second axis 532 define an angle 556. The angle 556 is preferably within the range of from about one degree to about twenty degrees. The illustrated angle 556 is more preferably about fifteen degrees.

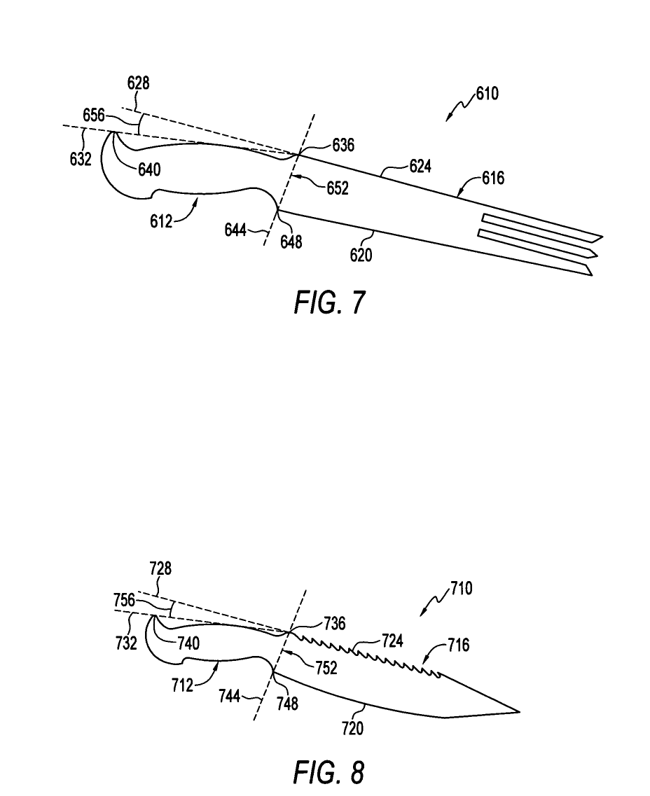

Referring now to FIG. 7, the illustrated relatively large sized knife having a forked end 610 includes a handle portion 612 and a blade portion 616. The handle portion 612 and the blade portion 616 are operatively connected. The handle portion 612 and the blade portion 616 are generally planar. The illustrated blade portion 616 includes a generally sharpened cutting edge 620. The cutting edge 620 may be serrated and/or plain edged. The illustrated blade portion 616 also includes a back edge 624. The illustrated back edge 624 is generally straight. The back edge 624 of the blade portion 616 is generally aligned along a first axis 628, as shown.

The handle portion 612 is generally aligned along a second axis 632, as shown. The illustrated second axis 632 generally extends from a first terminal point 636 on the back edge 624 of the blade portion 616 to an upward tip 640 of the handle portion 612. An illustrated third axis 644 intersects the first terminal point 636 on the back edge 624 of the blade portion 616 and the second terminal point 648 on the cutting edge 620 of the blade portion 616. It will be appreciated that the third axis 644 is generally perpendicular to the first axis 628, as shown.

The illustrated knife 610 includes a joint 652 as shown. It will be appreciated that the illustrated joint 652 is the place where the handle portion 612 and the blade portion 616 are joined. The illustrated joint 652 is generally about where the third axis 644 intersects the first terminal point on the back edge 624 of the blade portion 616 and the second terminal point on the cutting edge 620 of the blade portion 616.

It will be noted that the first axis 628 and the second axis 632 define an angle 656. The angle 656 is preferably within the range of from about one degree to about twenty degrees. The illustrated angle 656 is more preferably about fifteen degrees.

Referring now to FIG. 8, the illustrated relatively large sports military style knife with a jagged edge 710 includes a handle portion 712 and a blade portion 716. The handle portion 712 and the blade portion 716 are operatively connected. The handle portion 712 and the blade portion 716 are generally planar. The illustrated blade portion 716 includes a generally sharpened cutting edge 720. The cutting edge 720 may be serrated and/or plain edged. The illustrated blade portion 716 also includes a back edge 724. The illustrated back edge 724 is generally jagged. The back edge 724 of the blade portion 716 is generally aligned along a first axis 728, as shown.

The handle portion 712 is generally aligned along a second axis 732, as shown. The illustrated second axis 732 generally extends from a first terminal point 736 on the back edge 724 of the blade portion 716 to an upward tip 740 of the handle portion 712. An illustrated third axis 744 intersects the first terminal point 736 on the back edge 724 of the blade portion 716 and the second terminal point 748 on the cutting edge 720 of the blade portion 716. It will be appreciated that the third axis 744 is generally perpendicular to the first axis 728, as shown.

The illustrated knife 710 includes a joint 752 as shown. It will be appreciated that the illustrated joint 752 is the place where the handle portion 712 and the blade portion 716 are joined. The illustrated joint 752 is generally about where the third axis 744 intersects the first terminal point on the back edge 724 of the blade portion 716 and the second terminal point on the cutting edge 720 of the blade portion 716.

It will be noted that the first axis 728 and the second axis 732 define an angle 756. The angle 756 is preferably within the range of from about one degree to about twenty degrees. The illustrated angle 756 is more preferably about fifteen degrees.

Referring now to FIG. 10, the illustrated relatively large sized bread knife 810 includes a handle portion 812 and a blade portion 816. The handle portion 812 and the blade portion 816 are operatively connected. The handle portion 812 and the blade portion 816 are generally planar. The illustrated blade portion 816 includes a generally sharpened cutting edge 820. The cutting edge 820 may be serrated and/or plain edged. The illustrated blade portion 816 also includes a back edge 824. The illustrated back edge 824 is generally straight. The back edge 824 of the blade portion 816 is generally aligned along a first axis 828, as shown.

The handle portion 812 is generally aligned along a second axis 832, as shown. The illustrated second axis 832 generally extends from a first terminal point 836 on the back edge 824 of the blade portion 816 to an upward tip 840 of the handle portion 812. An illustrated third axis 844 intersects the first terminal point 836 on the back edge 824 of the blade portion 816 and the second terminal point 848 on the cutting edge 820 of the blade portion 816. It will be appreciated that the third axis 844 is generally perpendicular to the first axis 828, as shown.

The illustrated knife 810 includes a joint 852 as shown. It will be appreciated that the illustrated joint 852 is the place where the handle portion 812 and the blade portion 816 are joined. The illustrated joint 852 is generally about where the third axis 844 intersects the first terminal point on the back edge 824 of the blade portion 816 and the second terminal point on the cutting edge 820 of the blade portion 816.

It will be noted that the first axis 828 and the second axis 832 define an angle 856. The angle 856 is preferably within the range of from about one degree to about twenty degrees. The illustrated angle 856 is more preferably about fifteen degrees.

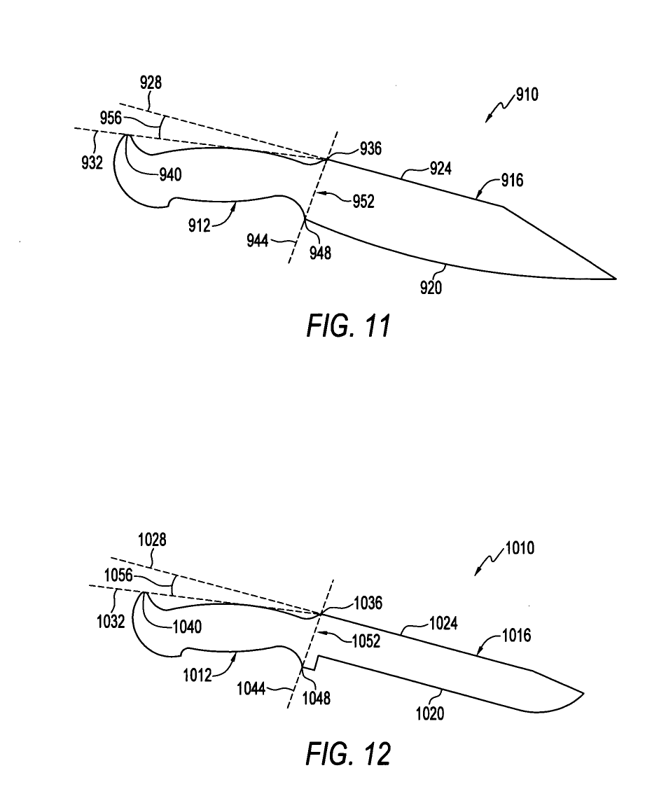

Referring now to FIG. 11, the illustrated relatively large sized butcher knife 910 includes a handle portion 912 and a blade portion 916. The handle portion 912 and the blade portion 916 are operatively connected. The handle portion 912 and the blade portion 916 are generally planar. The illustrated blade portion 916 includes a generally sharpened cutting edge 920. The cutting edge 920 may be serrated and/or plain edged. The illustrated blade portion 916 also includes a back edge 924. The illustrated back edge 924 is generally straight. The back edge 924 of the blade portion 916 is generally aligned along a first axis 928, as shown.

The handle portion 912 is generally aligned along a second axis 932, as shown. The illustrated second axis 932 generally extends from a first terminal point 936 on the back edge 924 of the blade portion 916 to an upward tip 940 of the handle portion 912. An illustrated third axis 944 intersects the first terminal point 936 on the back edge 924 of the blade portion 916 and the second terminal point 948 on the cutting edge 920 of the blade portion 916. It will be appreciated that the third axis 944 is generally perpendicular to the first axis 928, as shown.

The illustrated knife 910 includes a joint 952 as shown. It will be appreciated that the illustrated joint 952 is the place where the handle portion 912 and the blade portion 916 are joined. The illustrated joint 952 is generally about where the third axis 944 intersects the first terminal point on the back edge 924 of the blade portion 916 and the second terminal point on the cutting edge 920 of the blade portion 916.

It will be noted that the first axis 928 and the second axis 932 define an angle 956. The angle 956 is preferably within the range of from about one degree to about twenty degrees. The illustrated angle 956 is more preferably about fifteen degrees.

Referring now to FIG. 12, the illustrated relatively large sized carver knife 1010 includes a handle portion 1012 and a blade portion 1016. The handle portion 1012 and the blade portion 1016 are operatively connected. The handle portion 1012 and the blade portion 1016 are generally planar. The illustrated blade portion 1016 includes a generally sharpened cutting edge 1020. The cutting edge 1020 may be serrated and/or plain edged. The illustrated blade portion 1016 also includes a back edge 1024. The illustrated back edge 1024 is generally straight. The back edge 1024 of the blade portion 1016 is generally aligned along a first axis 1028, as shown.

The handle portion 1012 is generally aligned along a second axis 1032, as shown. The illustrated second axis 1032 generally extends from a first terminal point 1036 on the back edge 1024 of the blade portion 1016 to an upward tip 1040 of the handle portion 1012. An illustrated third axis 1044 intersects the first terminal point 1036 on the back edge 1024 of the blade portion 1016 and the second terminal point 1048 on the cutting edge 1020 of the blade portion 1016. It will be appreciated that the third axis 1044 is generally perpendicular to the first axis 1028, as shown.

The illustrated knife 1010 includes a joint 1052 as shown. It will be appreciated that the illustrated joint 1052 is the place where the handle portion 1012 and the blade portion 1016 are joined. The illustrated joint 1052 is generally about where the third axis 1044 intersects the first terminal point on the back edge 1024 of the blade portion 1016 and the second terminal point on the cutting edge 1020 of the blade portion 1016.

It will be noted that the first axis 1028 and the second axis 1032 define an angle 1056. The angle 1056 is preferably within the range of from about one degree to about twenty degrees. The illustrated angle 1056 is more preferably about fifteen degrees.

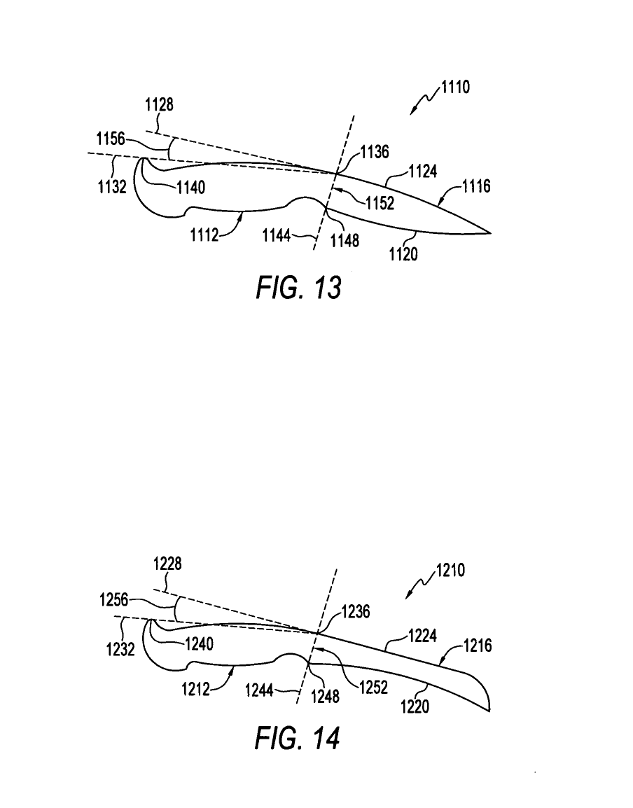

Referring now to FIG. 13, the illustrated relatively medium sized paring knife 1110 includes a handle portion 1112 and a blade portion 1116. The handle portion 1112 and the blade portion 1116 are operatively connected. The handle portion 1112 and the blade portion 1116 are generally planar. The illustrated blade portion 1116 includes a generally sharpened cutting edge 1120. The cutting edge 1120 may be serrated and/or plain edged. The illustrated blade portion 1116 also includes a back edge 1124. The illustrated back edge 1124 is generally curved. The back edge 1124 of the blade portion 1116 is generally aligned along a first axis 1128, as shown.

The handle portion 1112 is generally aligned along a second axis 1132, as shown. The illustrated second axis 1132 generally extends from a first terminal point 1136 on the back edge 1124 of the blade portion 1116 to an upward tip 1140 of the handle portion 1112. An illustrated third axis 1144 intersects the first terminal point 1136 on the back edge 1124 of the blade portion 1116 and the second terminal point 1148 on the cutting edge 1120 of the blade portion 1116. It will be appreciated that the third axis 1144 is generally perpendicular to the first axis 1128, as shown.

The illustrated knife 1110 includes a joint 1152 as shown. It will be appreciated that the illustrated joint 1152 is the place where the handle portion 1112 and the blade portion 1116 are joined. The illustrated joint 1152 is generally about where the third axis 1144 intersects the first terminal point on the back edge 1124 of the blade portion 1116 and the second terminal point on the cutting edge 1120 of the blade portion 1116.

It will be noted that the first axis 1128 and the second axis 1132 define an angle 1156. The angle 1156 is preferably within the range of from about one degree to about twenty degrees. The illustrated angle 1156 is more preferably about fifteen degrees.

Referring now to FIG. 14, the illustrated relatively medium sized bird's beak knife 1210 includes a handle portion 1212 and a blade portion 1216. The handle portion 1212 and the blade portion 1216 are operatively connected. The handle portion 1212 and the blade portion 1216 are generally planar. The illustrated blade portion 1216 includes a generally sharpened cutting edge 1220. The cutting edge 1220 may be serrated and/or plain edged. The illustrated blade portion 1216 also includes a back edge 1224. The illustrated back edge 1224 is generally straight. The back edge 1224 of the blade portion 1216 is generally aligned along a first axis 1228, as shown.

The handle portion 1212 is generally aligned along a second axis 1232, as shown. The illustrated second axis 1232 generally extends from a first terminal point 1236 on the back edge 1224 of the blade portion 1216 to an upward tip 1240 of the handle portion 1212. An illustrated third axis 1244 intersects the first terminal point 1236 on the back edge 1224 of the blade portion 1216 and the second terminal point 1248 on the cutting edge 1220 of the blade portion 1216. It will be appreciated that the third axis 1244 is generally perpendicular to the first axis 1228, as shown.

The illustrated knife 1210 includes a joint 1252 as shown. It will be appreciated that the illustrated joint 1252 is the place where the handle portion 1212 and the blade portion 1216 are joined. The illustrated joint 1252 is generally about where the third axis 1244 intersects the first terminal point on the back edge 1224 of the blade portion 1216 and the second terminal point on the cutting edge 1220 of the blade portion 1216.

It will be noted that the first axis 1228 and the second axis 1232 define an angle 1256. The angle 1256 is preferably within the range of from about one degree to about twenty degrees. The illustrated angle 1256 is more preferably about fifteen degrees.

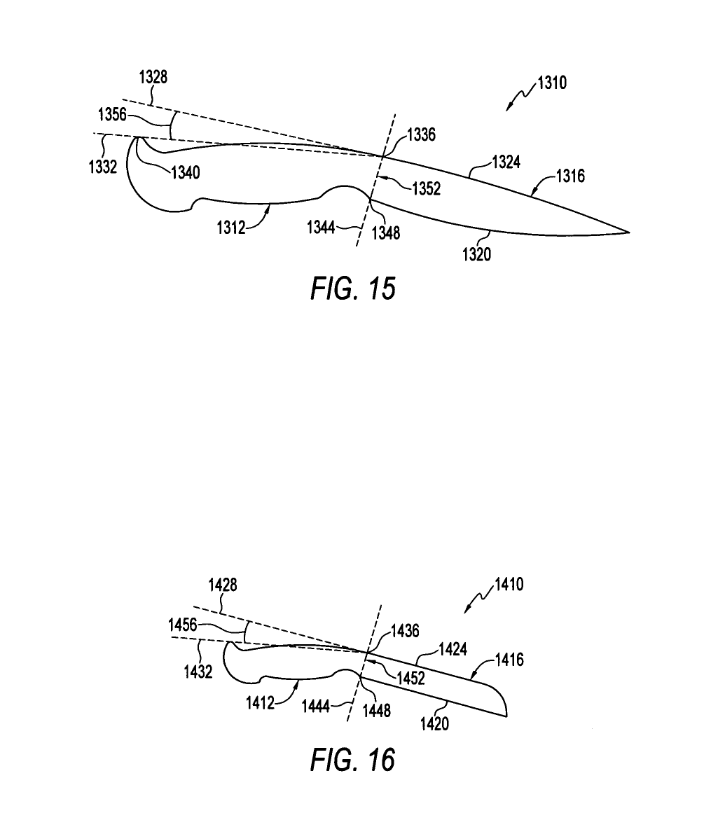

Referring now to FIG. 15, the illustrated relatively medium sized dicing knife 1310 includes a handle portion 1312 and a blade portion 1316. The handle portion 1312 and the blade portion 1316 are operatively connected. The handle portion 1312 and the blade portion 1316 are generally planar. The illustrated blade portion 1316 includes a generally sharpened cutting edge 1320. The cutting edge 1320 may be serrated and/or plain edged. The illustrated blade portion 1316 also includes a back edge 1324. The illustrated back edge 1324 is generally curved. The back edge 1324 of the blade portion 1316 is generally aligned along a first axis 1328, as shown.

The handle portion 1312 is generally aligned along a second axis 1332, as shown. The illustrated second axis 1332 generally extends from a first terminal point 1336 on the back edge 1324 of the blade portion 1316 to an upward tip 1340 of the handle portion 1312. An illustrated third axis 1344 intersects the first terminal point 1336 on the back edge 1324 of the blade portion 1316 and the second terminal point 1348 on the cutting edge 1320 of the blade portion 1316. It will be appreciated that the third axis 1344 is generally perpendicular to the first axis 1328, as shown.

The illustrated knife 1310 includes a joint 1352 as shown. It will be appreciated that the illustrated joint 1352 is the place where the handle portion 1312 and the blade portion 1316 are joined. The illustrated joint 1352 is generally about where the third axis 1344 intersects the first terminal point on the back edge 1324 of the blade portion 1316 and the second terminal point on the cutting edge 1320 of the blade portion 1316.

It will be noted that the first axis 1328 and the second axis 1332 define an angle 1356. The angle 1356 is preferably within the range of from about one degree to about twenty degrees. The illustrated angle 1356 is more preferably about fifteen degrees.

Referring now to FIG. 16, the illustrated relatively medium sized bagel knife 1410 includes a handle portion 1412 and a blade portion 1416. The handle portion 1412 and the blade portion 1416 are operatively connected. The handle portion 1412 and the blade portion 1416 are generally planar. The illustrated blade portion 1416 includes a generally sharpened cutting edge 1420. The cutting edge 1420 may be serrated and/or plain edged. The illustrated blade portion 1416 also includes a back edge 1424. The illustrated back edge 1424 is generally straight. The back edge 1424 of the blade portion 1416 is generally aligned along a first axis 1428, as shown.

The handle portion 1412 is generally aligned along a second axis 1432, as shown. The illustrated second axis 1432 generally extends from a first terminal point 1436 on the back edge 1424 of the blade portion 1416 to an upward tip 1440 of the handle portion 1412. An illustrated third axis 1444 intersects the first terminal point 1436 on the back edge 1424 of the blade portion 1416 and the second terminal point 1448 on the cutting edge 1420 of the blade portion 1416. It will be appreciated that the third axis 1444 is generally perpendicular to the first axis 1428, as shown.

The illustrated knife 1410 includes a joint 1452 as shown. It will be appreciated that the illustrated joint 1452 is the place where the handle portion 1412 and the blade portion 1416 are joined. The illustrated joint 1452 is generally about where the third axis 1444 intersects the first terminal point on the back edge 1424 of the blade portion 1416 and the second terminal point on the cutting edge 1420 of the blade portion 1416.

It will be noted that the first axis 1428 and the second axis 1432 define an angle 1456. The angle 1456 is preferably within the range of from about one degree to about twenty degrees. The illustrated angle 1456 is more preferably about fifteen degrees.

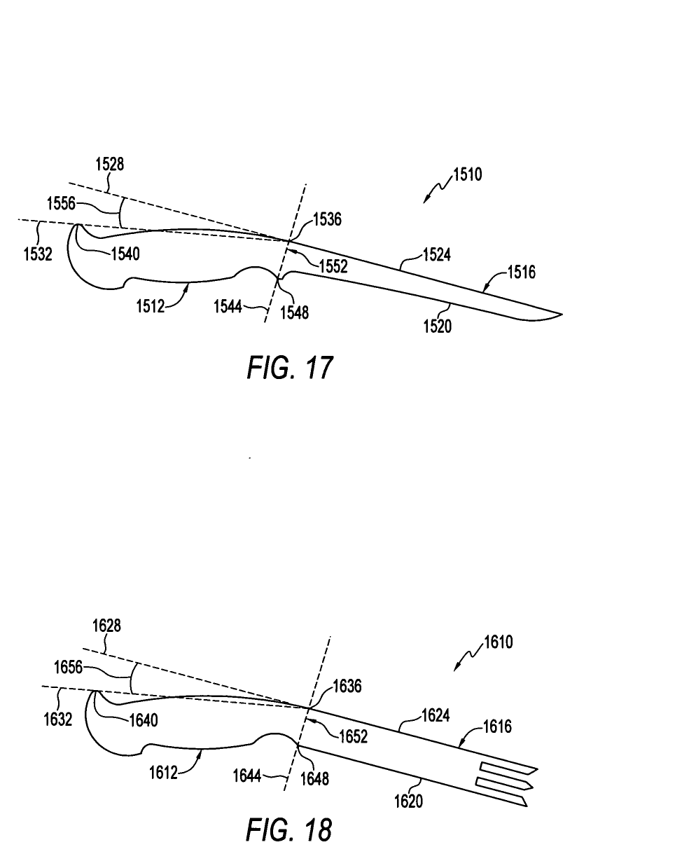

Referring now to FIG. 17, the illustrated relatively medium sized fillet knife 1510 includes a handle portion 1512 and a blade portion 1516. The handle portion 1512 and the blade portion 1516 are operatively connected. The handle portion 1512 and the blade portion 1516 are generally planar. The illustrated blade portion 1516 includes a generally sharpened cutting edge 1520. The cutting edge 1520 may be serrated and/or plain edged. The illustrated blade portion 1516 also includes a back edge 1524. The illustrated back edge 1524 is generally straight. The back edge 1524 of the blade portion 1516 is generally aligned along a first axis 1528, as shown.

The handle portion 1512 is generally aligned along a second axis 1532, as shown. The illustrated second axis 1532 generally extends from a first terminal point 1536 on the back edge 1524 of the blade portion 1516 to an upward tip 1540 of the handle portion 1512. An illustrated third axis 1544 intersects the first terminal point 1536 on the back edge 1524 of the blade portion 1516 and the second terminal point 1548 on the cutting edge 1520 of the blade portion 1516. It will be appreciated that the third axis 1544 is generally perpendicular to the first axis 1528, as shown.

The illustrated knife 1510 includes a joint 1552 as shown. It will be appreciated that the illustrated joint 1552 is the place where the handle portion 1512 and the blade portion 1516 are joined. The illustrated joint 1552 is generally about where the third axis 1544 intersects the first terminal point on the back edge 1524 of the blade portion 1516 and the second terminal point on the cutting edge 1520 of the blade portion 1516.

It will be noted that the first axis 1528 and the second axis 1532 define an angle 1556. The angle 1556 is preferably within the range of from about one degree to about twenty degrees. The illustrated angle 1556 is more preferably about fifteen degrees.

Referring now to FIG. 18, the illustrated relatively medium sized knife having a forked end 1610 includes a handle portion 1612 and a blade portion 1616. The handle portion 1612 and the blade portion 1616 are operatively connected. The handle portion 1612 and the blade portion 1616 are generally planar. The illustrated blade portion 1616 includes a generally sharpened cutting edge 1620. The cutting edge 1620 may be serrated and/or plain edged. The illustrated blade portion 1616 also includes a back edge 1624. The illustrated back edge 1624 is generally straight. The back edge 1624 of the blade portion 1616 is generally aligned along a first axis 1628, as shown.

The handle portion 1612 is generally aligned along a second axis 1632, as shown. The illustrated second axis 1632 generally extends from a first terminal point 1636 on the back edge 1624 of the blade portion 1616 to an upward tip 1640 of the handle portion 1612. An illustrated third axis 1644 intersects the first terminal point 1636 on the back edge 1624 of the blade portion 1616 and the second terminal point 1648 on the cutting edge 1620 of the blade portion 1616. It will be appreciated that the third axis 1644 is generally perpendicular to the first axis 1628, as shown.

The illustrated knife 1610 includes a joint 1652 as shown. It will be appreciated that the illustrated joint 1652 is the place where the handle portion 1612 and the blade portion 1616 are joined. The illustrated joint 1652 is generally about where the third axis 1644 intersects the first terminal point on the back edge 1624 of the blade portion 1616 and the second terminal point on the cutting edge 1620 of the blade portion 1616.

It will be noted that the first axis 1628 and the second axis 1632 define an angle 1656. The angle 1656 is preferably within the range of from about one degree to about twenty degrees. The illustrated angle 1656 is more preferably about fifteen degrees.

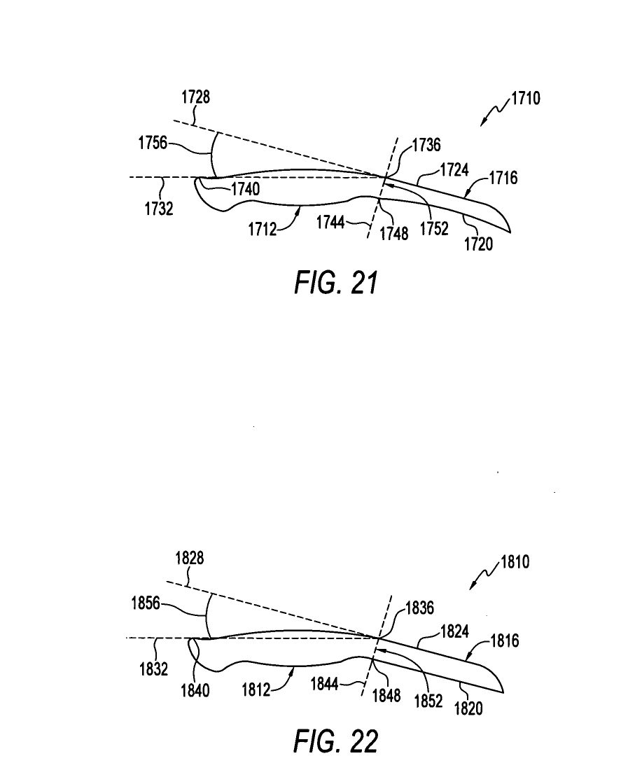

Referring now to FIG. 21, the illustrated relatively small sized bird's beak knife 1710 includes a handle portion 1712 and a blade portion 1716. The handle portion 1712 and the blade portion 1716 are operatively connected. The handle portion 1712 and the blade portion 1716 are generally planar. The illustrated blade portion 1716 includes a generally sharpened cutting edge 1720. The cutting edge 1720 may be serrated and/or plain edged. The illustrated blade portion 1716 also includes a back edge 1724. The illustrated back edge 1724 is generally straight. The back edge 1724 of the blade portion 1716 is generally aligned along a first axis 1728, as shown.

The handle portion 1712 is generally aligned along a second axis 1732, as shown. The illustrated second axis 1732 generally extends from a first terminal point 1736 on the back edge 1724 of the blade portion 1716 to an upward tip 1740 of the handle portion 1712. An illustrated third axis 1744 intersects the first terminal point 1736 on the back edge 1724 of the blade portion 1716 and the second terminal point 1748 on the cutting edge 1720 of the blade portion 1716. It will be appreciated that the third axis 1744 is generally perpendicular to the first axis 1728, as shown.

The illustrated knife 1710 includes a joint 1752 as shown. It will be appreciated that the illustrated joint 1752 is the place where the handle portion 1712 and the blade portion 1716 are joined. The illustrated joint 1752 is generally about where the third axis 1744 intersects the first terminal point on the back edge 1724 of the blade portion 1716 and the second terminal point on the cutting edge 1720 of the blade portion 1716.

It will be noted that the first axis 1728 and the second axis 1732 define an angle 1756. The angle 1756 is preferably within the range of from about one degree to about twenty degrees. The illustrated angle 1756 is more preferably about fifteen degrees.

Referring now to FIG. 22, the illustrated relatively small sized bread knife 1810 includes a handle portion 1812 and a blade portion 1816. The handle portion 1812 and the blade portion 1816 are operatively connected. The handle portion 1812 and the blade portion 1816 are generally planar. The illustrated blade portion 1816 includes a generally sharpened cutting edge 1820. The cutting edge 1820 may be serrated and/or plain edged. The illustrated blade portion 1816 also includes a back edge 1824. The illustrated back edge 1824 is generally straight. The back edge 1824 of the blade portion 1816 is generally aligned along a first axis 1828, as shown.

The handle portion 1812 is generally aligned along a second axis 1832, as shown. The illustrated second axis 1832 generally extends from a first terminal point 1836 on the back edge 1824 of the blade portion 1816 to an upward tip 1840 of the handle portion 1812. An illustrated third axis 1844 intersects the first terminal point 1836 on the back edge 1824 of the blade portion 1816 and the second terminal point 1848 on the cutting edge 1820 of the blade portion 1816. It will be appreciated that the third axis 1844 is generally perpendicular to the first axis 1828, as shown.

The illustrated knife 1810 includes a joint 1852 as shown. It will be appreciated that the illustrated joint 1852 is the place where the handle portion 1812 and the blade portion 1816 are joined. The illustrated joint 1852 is generally about where the third axis 1844 intersects the first terminal point on the back edge 1824 of the blade portion 1816 and the second terminal point on the cutting edge 1820 of the blade portion 1816.

It will be noted that the first axis 1828 and the second axis 1832 define an angle 1856. The angle 1856 is preferably within the range of from about one degree to about twenty degrees. The illustrated angle 1856 is more preferably about fifteen degrees.

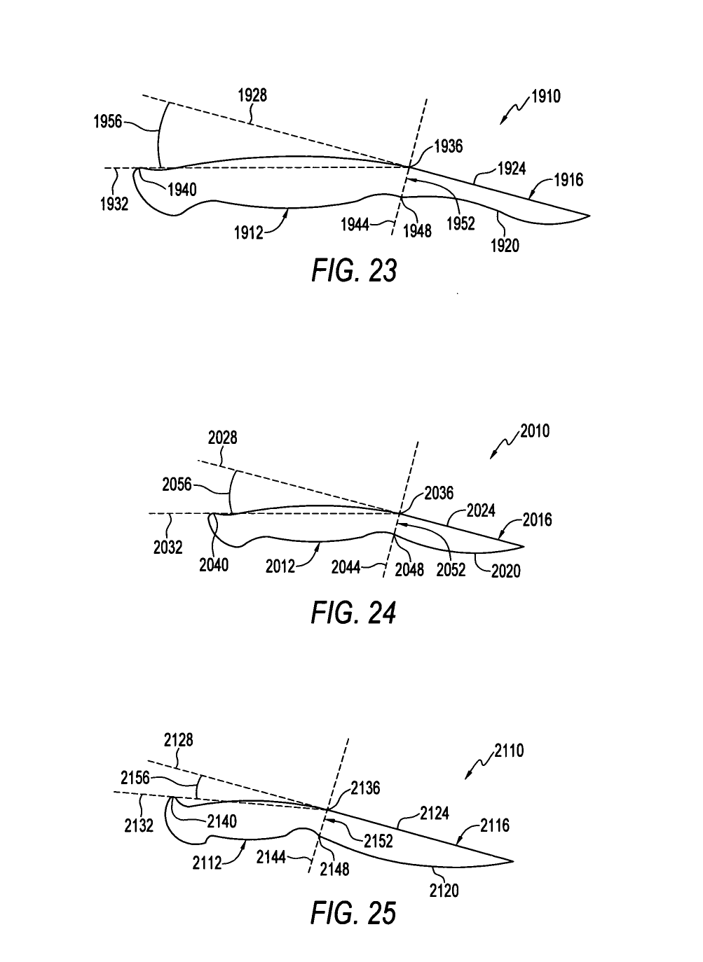

Referring now to FIG. 23, the illustrated relatively small carver knife 1910 includes a handle portion 1912 and a blade portion 1916. The handle portion 1912 and the blade portion 1916 are operatively connected. The handle portion 1912 and the blade portion 1916 are generally planar. The illustrated blade portion 1916 includes a generally sharpened cutting edge 1920. The cutting edge 1920 may be serrated and/or plain edged. The illustrated blade portion 1916 also includes a back edge 1924. The illustrated back edge 1924 is generally straight. The back edge 1924 of the blade portion 1916 is generally aligned along a first axis 1928, as shown.

The handle portion 1912 is generally aligned along a second axis 1932, as shown. The illustrated second axis 1932 generally extends from a first terminal point 1936 on the back edge 1924 of the blade portion 1916 to an upward tip 1940 of the handle portion 1912. An illustrated third axis 1944 intersects the first terminal point 1936 on the back edge 1924 of the blade portion 1916 and the second terminal point 1948 on the cutting edge 1920 of the blade portion 1916. It will be appreciated that the third axis 1944 is generally perpendicular to the first axis 1928, as shown.

The illustrated knife 1910 includes a joint 1952 as shown. It will be appreciated that the illustrated joint 1952 is the place where the handle portion 1912 and the blade portion 1916 are joined. The illustrated joint 1952 is generally about where the third axis 1944 intersects the first terminal point on the back edge 1924 of the blade portion 1916 and the second terminal point on the cutting edge 1920 of the blade portion 1916.

It will be noted that the first axis 1928 and the second axis 1932 define an angle 1956. The angle 1956 is preferably within the range of from about one degree to about twenty degrees. The illustrated angle 1956 is more preferably about fifteen degrees.

Referring now to FIG. 24, the illustrated relatively small paring knife 2010 includes a handle portion 2012 and a blade portion 2016. The handle portion 2012 and the blade portion 2016 are operatively connected. The handle portion 2012 and the blade portion 2016 are generally planar. The illustrated blade portion 2016 includes a generally sharpened cutting edge 2020. The cutting edge 2020 may be serrated and/or plain edged. The illustrated blade portion 2016 also includes a back edge 2024. The illustrated back edge 2024 is generally straight. The back edge 2024 of the blade portion 2016 is generally aligned along a first axis 2028, as shown.

The handle portion 2012 is generally aligned along a second axis 2032, as shown. The illustrated second axis 2032 generally extends from a first terminal point 2036 on the back edge 2024 of the blade portion 2016 to an upward tip 2040 of the handle portion 2012. An illustrated third axis 2044 intersects the first terminal point 2036 on the back edge 2024 of the blade portion 2016 and the second terminal point 2048 on the cutting edge 2020 of the blade portion 2016. It will be appreciated that the third axis 2044 is generally perpendicular to the first axis 2028, as shown.

The illustrated knife 2010 includes a joint 2052 as shown. It will be appreciated that the illustrated joint 2052 is the place where the handle portion 2012 and the blade portion 2016 are joined. The illustrated joint 2052 is generally about where the third axis 2044 intersects the first terminal point on the back edge 2024 of the blade portion 2016 and the second terminal point on the cutting edge 2020 of the blade portion 2016.

It will be noted that the first axis 2028 and the second axis 2032 define an angle 2056. The angle 2056 is preferably within the range of from about one degree to about twenty degrees. The illustrated angle 2056 is more preferably about fifteen degrees.

Referring now to FIG. 25, the illustrated relatively medium sized paring knife 2110 includes a handle portion 2112 and a blade portion 2116. The handle portion 2112 and the blade portion 2116 are operatively connected. The handle portion 2112 and the blade portion 2116 are generally planar. The illustrated blade portion 2116 includes a generally sharpened cutting edge 2120. The cutting edge 2120 may be serrated and/or plain edged. The illustrated blade portion 2116 also includes a back edge 2124. The illustrated back edge 2124 is generally straight. The back edge 2124 of the blade portion 2116 is generally aligned along a first axis 2128, as shown.

The handle portion 2112 is generally aligned along a second axis 2132, as shown. The illustrated second axis 2132 generally extends from a first terminal point 2136 on the back edge 2124 of the blade portion 2116 to an upward tip 2140 of the handle portion 2112. An illustrated third axis 2144 intersects the first terminal point 2136 on the back edge 2124 of the blade portion 2116 and the second terminal point 2148 on the cutting edge 2120 of the blade portion 2116. It will be appreciated that the third axis 2144 is generally perpendicular to the first axis 2128, as shown.

The illustrated knife 2110 includes a joint 2152 as shown. It will be appreciated that the illustrated joint 2152 is the place where the handle portion 2112 and the blade portion 2116 are joined. The illustrated joint 2152 is generally about where the third axis 2144 intersects the first terminal point on the back edge 2124 of the blade portion 2116 and the second terminal point on the cutting edge 2120 of the blade portion 2116.

It will be noted that the first axis 2128 and the second axis 2132 define an angle 2156. The angle 2156 is preferably within the range of from about one degree to about twenty degrees. The illustrated angle 2156 is more preferably about fifteen degrees.

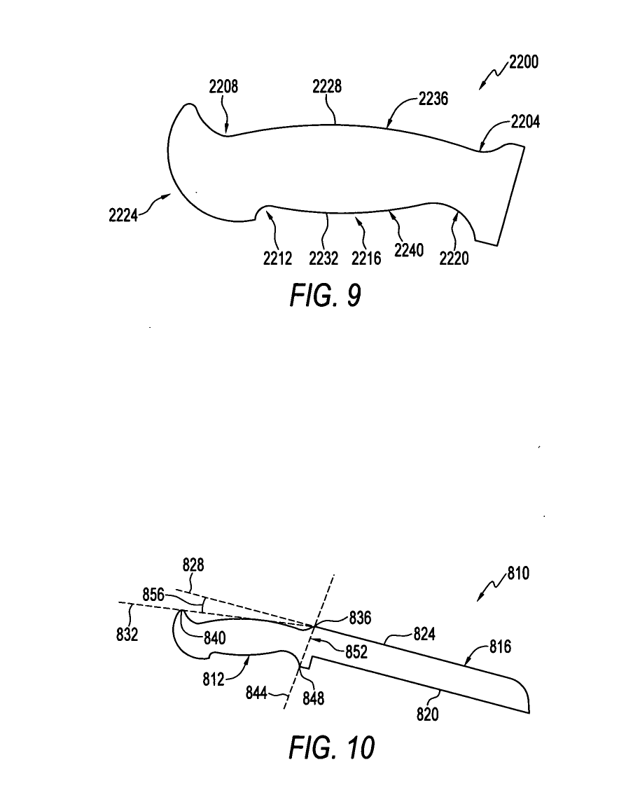

Handle coverings for use with the handle portions of the knives may be employed. Handle coverings are shown in FIGS. 9, 19 and 20. Any suitable handle covering may be employed. Two handle coverings may be employed for each handle portion of each knife. The knife handle portion may be generally sandwiched between two handle coverings. The handle coverings may be secured to the handle portion in any suitable manner, including by means of adhesive, rivets, fasteners, and the like. It will be appreciated that the contour of the handle coverings generally follows and/or mirrors the contour of the corresponding knife handle portion. Thus, a discussion of the physical structure of the handle coverings will generally apply to the physical structure of the handle portion of the knife unless otherwise made clear by the context.

Referring now to FIG. 9, a relatively large size handle covering 2200 is shown. The relatively large handle covering 2200 may be employed with any or all of the relatively large knives shown in this application or any other suitable knife. The illustrated handle covering 2200 is generally planar. The illustrated handle covering 2200 includes five stress points. The first stress point is shown generally at 2204. The second stress point is shown generally at 2208. The third stress point is shown generally at 2212. The fourth stress point is shown generally at 2216. The fifth stress point is shown generally at 2220. The term “stress point” is understood to include a point where a relatively greater force is exerted by a portion of a hand pressing and/or squeezing on it. It will be noted that the illustrated handle portions of the illustrated knives similarly include these five stress points as well as the other structural features discussed herein.

A number of other terms may be helpful for understanding the drawings of the handle portions of the knives and the handle coverings of the knives. The term “cupped” is understood to include a structure generally curve into the general shape of a cup. It also may include a recess, dip and/or indentation. The term “belly” is understood to include a surface or object generally curved and/or generally rounded. The term “knob” is understood to include a variety of generally rounded protuberances. The term “contiguous” is understood to include the state of being generally in line and/or touching and/or being generally connected throughout in a generally unbroken fashion.

The illustrated handle covering 2200 includes a knob 2224. The illustrated handle covering 2200 includes a first belly 2228 and a second belly 2232. The first stress point 2204 and the second stress point 2208 are located on a back side 2236 of the illustrated handle covering 2200. The third 2212 stress point and fourth stress point 2216 and fifth stress point 2220 are on a front side 2240 of the illustrated handle covering 2200. The back side 2236 of the handle covering 2200 is generally contiguous with the back, relative non-sharp portion of the of the blade portion of the knife. The front side 2240 of the handle covering 2200 is generally contiguous with the front, relatively sharp portion of the blade portion of the knife.

The first stress point 2204 is generally located on a cupped portion of the handle covering 2200. The second stress point 2208 is generally located on a cupped portion of the handle covering 2200. The first stress point 2204 and the second stress point 2208 are generally separated by the first belly 2228 of the illustrated handle covering 2200. The third stress point 2212 is generally located on a cupped portion of the handle covering 2200. The fifth stress point 2220 is generally located on a cupped portion of the handle covering 2200. The fourth stress point 2216 is generally located on the second belly 2232 of the handle covering 2200.

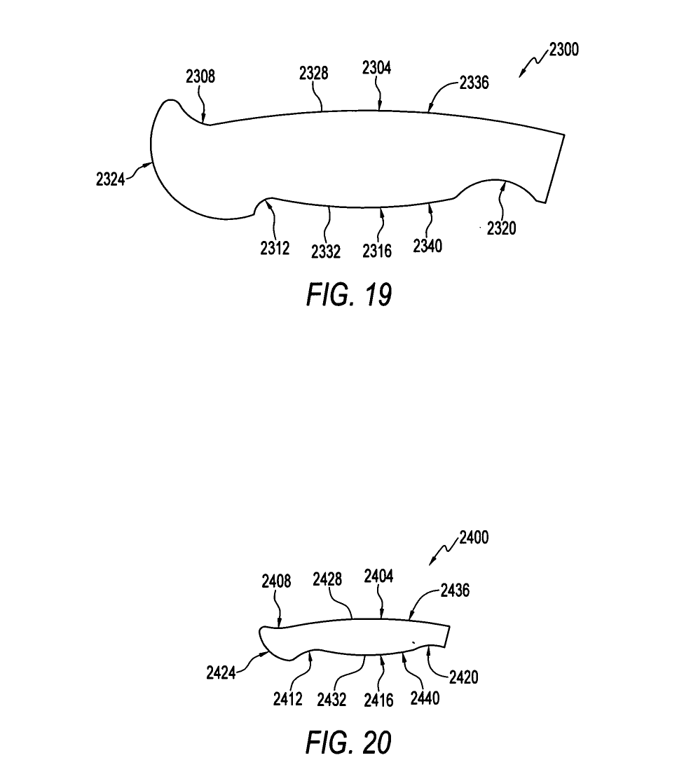

Referring now to FIG. 19, a relatively medium size handle covering 2300 is shown. The handle covering 2300 may be employed with any or all of the relatively medium sized knives shown in this application or any other suitable knife. The illustrated handle covering 2300 is generally planar. The illustrated handle covering 2300 includes five stress points. The first stress point is shown generally at 2304. The second stress point is shown generally at 2308. The third stress point is shown generally at 2312. The fourth stress point is shown generally at 2316. The fifth stress point is shown generally at 2320.

The illustrated handle covering 2300 includes a knob 2324. The illustrated handle covering 2300 includes a first belly 2328 and a second belly 2332. The first stress point 2304 and the second stress point 2308 are located on a back side 2336 of the illustrated handle covering 2300. The third 2312 stress point and fourth stress point 2316 and fifth stress point 2320 are on a front side 2340 of the illustrated handle covering 2300. When secured to the knife, the back side 2336 of the handle covering 2300 is generally contiguous with the back, relative non-sharp portion of the of the blade portion of the knife. When secured to the knife, the front side 2340 of the handle covering 2300 is generally contiguous with the front, relatively sharp portion of the blade portion of the knife.

The first stress point 2304 is generally located on the first belly 2328 of the handle covering 2300. The second stress point 2308 is generally located on a cupped portion of the handle covering 2300. The third stress point 2312 is generally located on a cupped portion of the handle covering 2300. The fifth stress point 2320 is generally located on a cupped portion of the handle covering 2300. The fourth stress point 2316 is generally located on the second belly 2332 of the handle covering 2300.

Referring now to FIG. 20, a relatively small size handle covering 2400 is shown. The handle covering 2400 may be employed with any or all of the relatively small sized knives shown in this application or any other suitable knife. The illustrated handle covering 2400 is generally planar. The illustrated handle covering 2400 includes five stress points. The first stress point is shown generally at 2404. The second stress point is shown generally at 2408. The third stress point is shown generally at 2412. The fourth stress point is shown generally at 2416. The fifth stress point is shown generally at 2420.

The illustrated handle covering 2400 includes a knob 2424. The illustrated handle covering 2400 includes a first belly 2428 and a second belly 2432. The first stress point 2404 and the second stress point 2408 are located on a back side 2436 of the illustrated handle covering 2400. The third 2412 stress point and fourth stress point 2416 and fifth stress point 2420 are on a front side 2440 of the illustrated handle covering 2400. When secured to the knife, the back side 2436 of the handle covering 2400 is generally contiguous with the back, relative non-sharp portion of the of the blade portion of the knife. When secured to the knife, the front side 2440 of the handle covering 2400 is generally contiguous with the front, relatively sharp portion of the blade portion of the knife.

The first stress point 2404 is generally located on the first belly 2428 of the handle covering 2400. The second stress point 2408 is generally located on a cupped portion of the handle covering 2400. The third stress point 2412 is generally located on a cupped portion of the handle covering 2400. The fifth stress point 2420 is generally located on a cupped portion of the handle covering 2400. The fourth stress point 2416 is generally located on the second belly 2432 of the handle covering 2400.

The fifth stress points 2220, 2320, 2420 are pivot points. The term “pivot point” is understood to include a point or region on which something balances, turns, moves and/or rotates. It will be appreciated that a finger, including a forefinger, thumb or other suitable finger, can be place on the pivot points of one or more knives. Using a knife by placing a finger on the pivot point and moving the blade can be advantages in cutting or otherwise using the knife. While the pivot point is particularly useful for the paring knives, it may be employed with any suitable knife.

The principle and mode of operation of this invention have been described in its preferred embodiments. However, it should be noted that this invention may be practiced otherwise than as specifically illustrated and described without departing from its scope.

What is claimed is:

1. A method of using a knife comprising:
providing a knife having a blade portion and a handle portion, the handle portion having a pivot point at one end of the handle portion and a knob defined by two cupped regions at the other end of the handle portion;
placing a thumb in the pivot point; and
moving the blade portion of the knife.

2. The method of claim 1 wherein the finger is a thumb.

3. The method of claim 1 wherein the finger is a forefinger.

4. The method of claim 1 wherein the pivot point is generally located on a cupped region of the handle portion.

5. The method of claim 1 wherein the handle portion has a tip on a back side of the handle portion.

6. The method of claim 5 wherein the handle portion has two bellies.

7. The method of claim 1 wherein the blade portion and the handle portion are located at an acute angle to each other.

8. The method of claim 7 wherein the angle is within the range of from about one degree to about twenty degrees.

9. The method of claim 8 wherein the angle is about fifteen degrees.

10. The method of claim 1 wherein the handle portion includes five stress points.

11. A method of using a knife comprising:
providing a knife having a blade portion and a handle portion, the handle portion having a pivot point at one end of the handle portion and a knob defined by two cupped regions at the other end of the handle portion, wherein the handle portion has five stress points;
placing a thumb in the pivot point; and
moving the blade portion of the knife.

12. The method of claim 11 wherein the finger is a thumb.

13. The method of claim 11 wherein the finger is a forefinger.

14. The method of claim 11 wherein the pivot point is generally located on a cupped region of the handle portion.

15. The method of claim 11 wherein the handle portion has a tip on a back side of the handle portion.

16. The method of claim 15 wherein the handle portion has two bellies.

17. The method of claim 11 wherein the blade portion and the handle portion are located at an acute angle to each other.

18. The method of claim 17 wherein the angle is within the range of from about one degree to about twenty degrees.

19. The method of claim 18 wherein the angle is about fifteen degrees.

20. The method of claim 11 further comprising a handle covering operatively connected to the handle portion wherein the handle covering includes five stress points.
